(19) United States
(12) Patent Application Publication
(10) Pub. No.: US 2011/0072092 A1
(43) Pub. Date: Mar. 24, 2011

(54) Message Mapping Management for Online Service Applications

(75) Inventors: Bettina Zedlitz, Wiesloch (DE); Hans-Joerg Rutsch, Walldorf (DE); Patrick Zimmer, Walldorf (DE)

(73) Assignee: SAP AG, Walldorf (DE)

(21) Appl. No.: 12/565,650

(22) Filed: Sep. 23, 2009

(51) Int. Cl. G06F 15/16

(52) U.S. Cl. 709/206

(57) ABSTRACT

The semantic message maintenance system provides a tool for a system with a backend and set of intermediate systems to maintain semantics of a message such that the end user can receive the information provided by the backend system in a manner that is comprehendible to the end user who has no specific knowledge of the functioning of the backend system. A message mapping system uses a series of mapping definitions and standardized identification fields. Both variable data textual data can be preserved.

### BACKGROUND

1. Field of the Invention

The Embodiments of the invention relate to a method and system for messaging across multiple systems. Specifically, embodiments of the invention relate to a method and system for maintaining message semantics across multiple message formats and multiple systems.

2. Background

In many online services systems, messages are passed across multiple systems where the format of the messaging changes at the interfaces between these systems. For example, an end user of an online service may request information available in a backend system such as an enterprise resource planning system, which in turn may be available to the online service through an enterprise service layer. The end user generates a message containing a request for information to the online service. The online service then generates a query through the enterprise service layer to be serviced by the enterprise resource planning system. In the situation where an error occurs, for example where the requested information is not available, then the enterprise resource planning system generates an error message.

The error message generated by the enterprise resource planning system may specify that the requested information does not exist in its database. This message is then returned to through the enterprise service layer to the online service system, which in turn responds to the user. However, in the process of passing this message back through the enterprise service layer and the online service system the semantics of the error message are lost.

The original message may specify that the requested information is not available in its database. This message will be passed back through the enterprise service layer. The enterprise service layer processes this message and generates a generic error message or an error message identified simply by a code. As similar processing can occur at the online service system. The end user receives a coded or generic message. As a result, the end user who has no knowledge of the function and structure of the enterprise resource planning system cannot interpret the meaning of the message. The end user is not provided with the information that was generated at the enterprise resource planning system due to the changes in format of the message in the intermediate systems.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1 is a diagram of one embodiment of a system for maintaining message semantics across intermediate systems.

FIG. 2 is flowchart of one embodiment of a process for maintaining message semantics.

FIG. 3A is a diagram illustrating an example application of the system and method for maintaining message semantics.

FIG. 3B is a diagram illustrating an example application of the system and method for maintaining message semantics.

### DETAILED DESCRIPTION

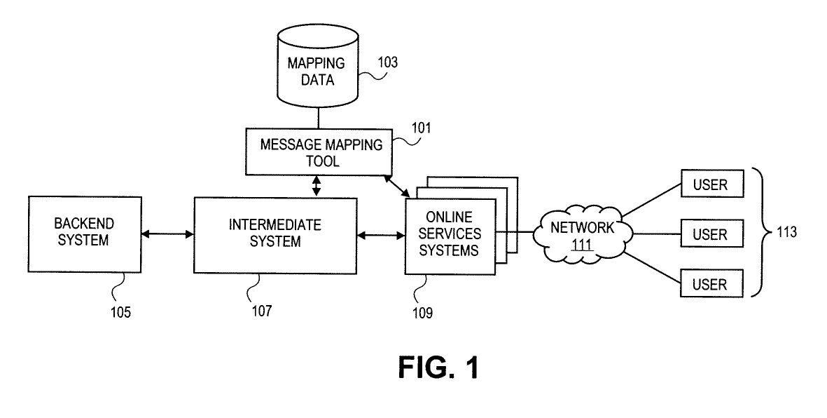

FIG. 1 is a diagram of one embodiment of a system for maintaining message semantics across the intermediate systems. The system may include a message mapping tool 101, mapping data 103, backend system 105, intermediate system 107, online service system 109, network 111, and a set of user systems 113. A ‘set,’ as used herein refers to any positive whole number of items including one item. The end user systems 113 can be any type of computer system running any type of applications that might request data from an online service system. The end user systems 113 can be workstations, desktop computers, laptop computers, hand held computers, dedicates servers or similar computing devices.

The network 111 can be any type of networking system including a local area network (LAN), a wide area network (WAN), such as the Internet, or similar communication system. The network 111 can connect any number of end user systems 113 and online service systems 109. Each end user system 113 can be connected to separate distinct online service systems 109. These online service systems 109 can provide connections for the end user systems 113 to separate or any combination of intermediate 107 or backend systems 105. The mapping tool 101 can be in communication with or a part of any combination of online services system 109 and intermediate systems.

The online service system 109 provides access for end user systems 113 to any type of online services data. These online service systems 109 can include web servers, data base access servicers, applications servers and similar resource access systems. The intermediate system 107 can be middle ware, an enterprise service layer or similar intermediate system. The backend system 105 can be any type of data management or similar resource management system such as an enterprise resource planning system or database management system. The number, structure and type of the end user systems 113, intermediate systems 107, online services systems 109 and backend systems 105 are provided by way of example. One of ordinary skill in the art would understand that any combination or number of intermediate systems 107, end user systems 113, backend systems 105 and online services systems 109 can be utilized with the message semantics maintenance system.

A message mapping tool 101 can communicate with the intermediate system 107 and online services system 109. In another embodiment, a separate message mapping tool 101 is utilized by each intermediate system 107 and online services system 109 or is embedded in each system. Each message mapping tool 101 can have a separate set of mapping data 103 or can share mapping data 103. The mapping data 103 can be stored in a database or similar data storage system. The mapping data 103 can be organized as a set of definitions or rules for mapping the fields of different message formats used in the different systems. These mapping definitions when applied can preserve the semantics of the messages across each system.

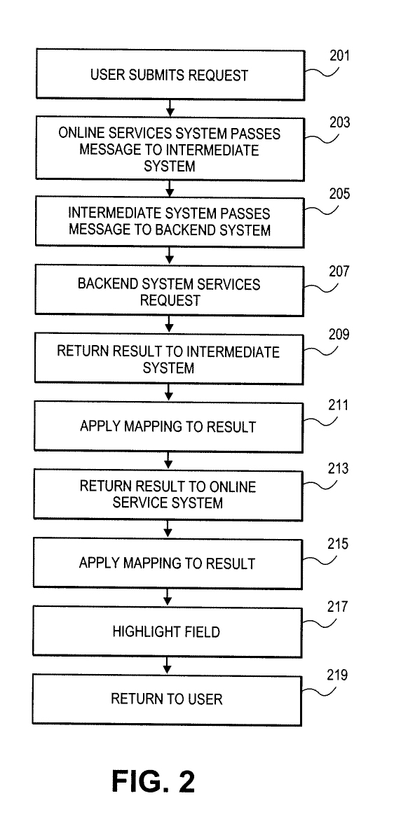

FIG. 2 is a flowchart of one embodiment of the process of message semantic maintenance. In one embodiment, the process is initiated in response to the end user system submitting a request to an online services system (Block 201). This request can have any format and can request any type of data or resource that is managed by the backend system or that can be made through an online service system. This request can be received over a network through any number of intermediate nodes in the network before reaching the online services system. In one embodiment, the online service system receives the message and passes it to an intermediate system (Block 203). The request can be passed to the intermediate system by generating a query or message that involves a change in protocol or format from the request received by the online services system.

Similarly, the intermediate system (e.g., an enterprise service layer) passes the message or a query to the backend system (Block 205). The passing of a request or message to a backend system can involve a change in messaging format or protocol. For example, the protocol between the backend system and intermediate system can be a remote function call (RFC) or enterprises service message or similar protocol.

The backend system then services the request and generates the response which may be a confirmation, an error message, data requested or similar response. The result is returned to the intermediate system using a messaging format or protocol specific to the interface between the backend system and intermediate system (Block 209). At this point, the full semantics of that response message are available to the intermediate system. The intermediate system, however, uses a separate or different protocol or message format to communicate with the online services system than that which was utilized to communicate with the backend system.

To maintain the semantics of the data, the data is mapped to the new format (Block 211). In one embodiment, this involves the use of X-path notation to describe each of the fields or the relevant fields of a message protocol. The mapping can be specified by a set of mapping definitions and can be carried out by a mapping tool. A corresponding mapping definition can be looked up in a database of mapping definitions using the X-path or similar identifier. The mapping transfers the semantic data of the format or protocol of the backend system to that of the intermediate system such that is not lost. The mapping definitions can be crafted for specific protocol or message type conversions or for specific backend system and intermediate systems interfaces. The mapping definitions can specify each element of first message format or protocol to be converted or transferred to the second message format or protocol. The data being transferred or converted can be textual data or variable data. The mapping definitions can be generated by a developer to handle specified backend systems, intermediate systems, online services systems and similar relational mappings. In a further embodiment, these definitions can also be modified and created by an administrator (e.g., a customer of the developer) to meet the specific needs or configurations of the deployed system.

The mapped result is then passed on to the next system such as the online service system (Block 213). A similar process of mapping the message data can be carried out at the intermediate system (Block 205). Each of the elements that can be lost in the transition between message formats and protocols can be mapped using an X-path notation or similar notation. Another mapping definition can specify the semantics of the message or protocol received by the intermediate system or at least the relevant semantics that are useful to the end user or that can be lost. Applying the mapping ensures that this data is preserved in the new format or protocol.

The result of the mapping can also be analyzed to identify the fields, or similar aspects of the message or protocol that have been mapped or preserved by including an indicator that the fields are to be highlighted, for example, relevant text fields or data fields can be identified (Block 217). This highlighting can be carried out by the mapping tool based on analysis of data fields of the message to indicate the most important fields, preserved or mapped fields or similar relevant fields. For example, if the message is an error message then the fields into which the error has been mapped or that correspond to those that were initially requested can be highlighted to draw the user's attention to those fields. The result of the mapping and highlighting can then be returned to the user and displayed (Block 219).

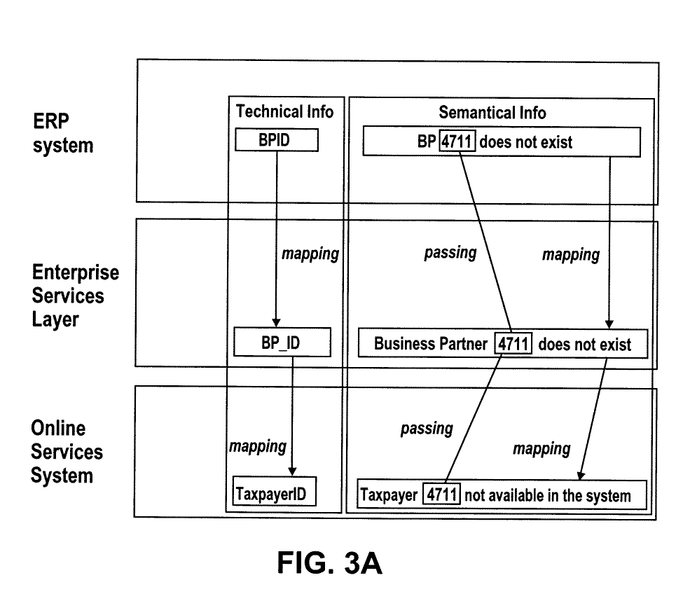

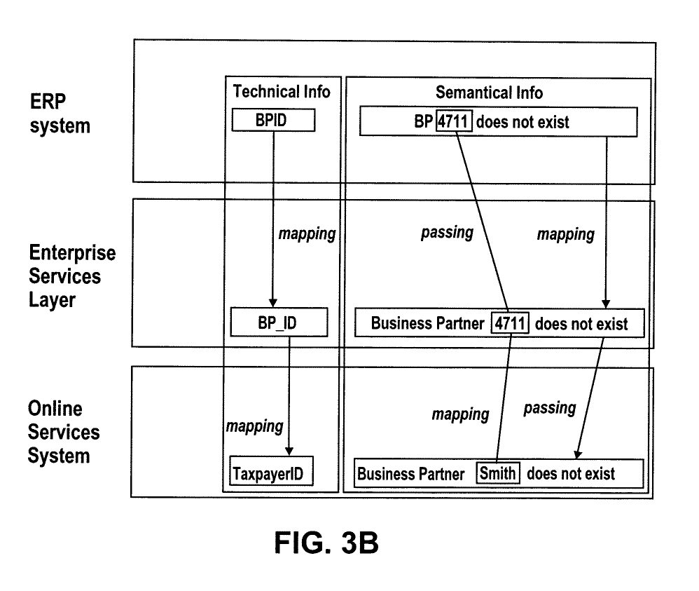

FIG. 3A is one example of an embodiment of the application of the invention for text mapping. The diagram shows the passing of messages across each layer a system including an online services system, an intermediate layer (i.e., the enterprise services layer), and the backend system (e.g., ERP system) including text fields and variable fields that have been changed across each message format. As a result, semantics of the data are lost. With the mapping applied the data is mapped and maintained across each message thereby preserving the semantics of the data for the user.

In the illustrated example, data is being returned from the ERP system (i.e., the backend system). In the example, the end user has requested information about a taxpayer from the ERP system. The message semantics at the ERP system indicate that a BP (“business partner”) number 4711, which is a tax payer, does not exist in the ERP system. This BP number is passed back without mapping. However, the semantics of the associated text “does not exist” are mapped at each stage to maintain this information and present it to the end user such that it is clear that the taxpayer 4711 is not available in the system. This is an example of text mapping. Also the identification information in the form of the BPID is maintained over each conversion by mapping it to the relevant field of the next format.

FIG. 3A is one example of an embodiment of the application of the invention for variable mapping. In this case, the mapping definitions translate the meaning of a variable from one format to another. The text data is not mapped in this example. However, one skilled in the art would understand that any combination of text and variable mapping can be performed. The identifier of the requested tax payer provided in the ERP system error message is mapped according to the mapping definition to translate it to the name of the individual. In each technique, variable mapping and text mapping or similar mapping techniques can be utilized consistent with the structures, principles and features described herein to preserve the semantics of backend systems or intermediate systems to be presented to an end user.

In one embodiment, the message semantic maintenance system can be implemented as a set of hardware devices. In another embodiment, the system components are implemented in software (for example microcode, assembly language or higher level languages). These software implementations can be stored on a computer-readable medium. A “computer-readable” medium can include any medium that can store information. Examples of the computer-readable medium include a read only memory (ROM), a floppy diskette, a CD Rom, a DVD, a flash memory, a hard drive, an optical disc or similar medium.

In the foregoing specification, the invention has been described with references to specific embodiments. It will, however, be evident that various modifications and changes can be made thereto without departing from the broader spirit and scope that is set forth in the appended claims. The specification and drawings are accordingly to be regarded in illustrative rather than a restrictive sense.

What is claimed is:

1. A method comprising:
receiving a user request;
passing the user request to a backend system by an intermediate system;
receiving a result from the backend system; and
mapping an element of the result by a computer system, the element having a semantic of the backend system to a semantic of the user request.

2. The method of claim 1, wherein the element of the result is a text field.

3. The method of claim 1, wherein the element of the result is a variable.

4. The method of claim 1, further comprising:
identifying a mapping definition from an identifier in the result.

5. The method of claim 4, wherein the identifier is an X-path.

6. The method of claim 1, further comprising:
receiving the result from the intermediate system;
mapping the element of the result having a semantic of the intermediate system to a semantic of the user request.

7. The method of claim 1, further comprising:
looking up a mapping definition in a mapping definition database.

8. The method of claim 1, wherein the result is an enterprise service message or a remote function call message.

9. A system comprising:
an intermediate system to receive a request from a user system and a response from a backend system; and
a mapping tool in communication with the intermediate system to convert a field of a response to a semantic of the user system.

10. The system of claim 9, wherein the mapping tool identifies a conversion based on an identifier field in the response.

11. The system of claim 9, further comprising:
an online services system to receive a request from the user system and a response from the intermediate system and to convert the field of the response from a semantic of the intermediate system to a semantic of the user system.

12. The system of claim 9, wherein the field is a text field or a variable.

13. A computer-readable medium, having instructions stored thereon, which when executed, cause a computer to perform a set of operations comprising:
receiving a user request;
passing the user request to a backend system by an online services system;
receiving a result from the backend system; and
mapping an element of the result by a computer system, the element having a semantic of an intermediate system to a semantic of the user request.

14. The computer-readable medium of claim 13, wherein the element of the result is a text field.

15. The computer-readable medium of claim 13, wherein the element of the result is a variable.

16. The computer-readable medium of claim 13, further comprising:
identifying a mapping definition from an identifier in the result.

17. The computer-readable medium of claim 16, wherein the identifier is an X-path.

18. The computer-readable medium of claim 13, having further instructions stored therein, which when executed cause the computer to perform a set of operations further comprising:
receiving the result from the backend system; and
mapping the element of the result having a semantic of the backend system to a semantic of the intermediate system.

19. The computer-readable medium of claim 13, having further instructions stored therein, which when executed cause the computer to perform a set of operations further comprising:
looking up a mapping definition in a mapping definition database.

20. The computer-readable medium of claim 13, wherein the result is an enterprise service message or a remote function call message.
